(19) United States
(12) Patent Application Publication
(10) Pub. No.: US 2007/0103392 A1
(43) Pub. Date: May 10, 2007

(54) Plasma display and driving method thereof

(76) Inventors: Seung-Min Kim, Suwon-si (KR); Woo-Joon Chung, Suwon-si (KR)

Correspondence Address: Robert E. Bushnell, Suite 300, 1522 K Street, N.W., Washington, DC, 20005-1202, US

(21) Appl. No.: 11/585,173

(22) Filed: Oct. 24, 2006

(30) Foreign Application Priority Data
Nov. 8, 2005 (KR) 10-2005-0106349

(51) Int. Cl. G09G 3/28

(52) U.S. Cl. 345/60

(57) ABSTRACT

A plasma display calculates a screen load ratio from a plurality of video signals input during one frame, determines a total number of sustain pulses of the frame according to the screen load ratio, and determines a number of sustain pulses allocated to each subfield from the total number of sustain pulses. In addition, the plasma display divides a first number of sustain pulses allocated to at least one of the plurality of subfields into a second number of sustain pulses having a first period and a third number of sustain pulses having a second period different from the first period.

### CLAIM OF PRIORITY

This application makes reference to, incorporates the same herein, and claims all s benefits accruing under 35 U.S.C. §119 from an application for PLASMA DISPLAY AND DRIVING METHOD THEREOF earlier filed in the Korean Intellectual Property Office on the 8 Nov. 2005 and there duly assigned Serial No. 10-2005-0106349.

### BACKGROUND OF THE INVENTION

1. Field of the Invention

The present invention relates to a plasma display and a driving method thereof. More particularly, the present invention relates to sustain pulse allocation in a plasma display.

2. Description of the Related Art

A plasma display is a flat panel display that uses a plasma generated by gas discharge to display characters or images. It includes, depending on its size, more than several scores to millions of discharge cells. According to one driving method of a plasma display, each frame is divided into a plurality of subfields, each of the subfields having a weight. On-cells or off-cells are selected during an address period of each subfield. Sustain pulses corresponding to the weight of each subfield are supplied to the discharge cells such that sustain discharges occur in the on-cells. The on-cells express a grayscale by a combination of the weights of the light-emitting subfields.

In such a plasma display, the luminance is not increased in proportion to the number of sustain pulses. Generally, according to a saturation characteristic of a phosphor, a brightness increase rate is relatively large in the case of a small number of sustain pulses and the brightness increase rate is relatively small in the case of a large number of sustain pulses. In addition, the brightness displayed by the same number of sustain pulses is changed according to the screen load ratio. Accordingly, plasma displays are limited in displaying a desired brightness only by the number of sustain pulses constantly allocated at each subfield.

### SUMMARY OF THE INVENTION

One aspect of the present invention provides a plasma display and a driving method thereof having advantages of achieving brightness by other factors excluding the number of sustain pulses.

According to another aspect of the present invention, sustain pulses having different periods are used in one subfield.

An exemplary embodiment of the present invention provides a method of driving a plasma display in which one frame is divided into a plurality of subfields each having a respective weight, the method including: calculating a screen load ratio from a plurality of video signals input during one frame; determining a total number of sustain pulses of the frame according to the screen load ratio; determining a number of sustain pulses allocated to each subfield from the total number of sustain pulses; and dividing a first number of sustain pulses allocated to at least one of the plurality of subfields into a second number of sustain pulses having a first period and a third number of sustain pulses having a second period different from the first period.

Each sustain pulse preferably alternately has a high level voltage and a low level voltage, and each of the first and second periods is preferably determined by a first time in which the sustain pulse is increased from a value equal to a predetermined percentage of the low level voltage to a value equal to a predetermined percentage of the high level voltage and a second time in which the sustain pulse is decreased from a value equal to a predetermined percentage of the high level voltage to a value equal to a predetermined percentage of the low level voltage.

Determining the number of sustain pulses preferably includes allocating the number of sustain pulses to the plurality of subfields such that the number of sustain pulses allocated to each subfield is proportional to the weight of the respective subfield.

A ratio of the second number relative to the first number is preferably increased in response to the screen load ratio increasing, and the first period is preferably shorter than the second period.

The ratio of the second number relative to the first number preferably corresponds to the screen load ratio.

The method preferably further includes: converting each of the plurality of video signals into a plurality of subfield data; and calculating a display load ratio of each subfield from the plurality of subfield data corresponding to the respective subfield; a ratio of the second number relative to the first number is increased in response to the display load ratio increasing; and the first period is preferably shorter than the second period.

The ratio of the second number relative to the first number preferably corresponds to the display load ratio of each subfield.

The third number is preferably equal to a difference between the first number and the second number.

The first number of sustain pulses preferably further includes at least one sustain pulse having a third period different from the first and second periods.

Another exemplary embodiment of the present invention provides a plasma display including: a plurality of discharge cells; a controller adapted to: divide one frame into a plurality of subfields each having a respective weight; allocate a plurality of sustain pulses to the plurality of subfields according to the weights thereof, and to divide sustain pulses allocated to at least one of the plurality of subfields into at least one first sustain pulse having a first period and at least one second sustain pulse having a second period; and a driver adapted to supply the at least one first sustain pulse and the at least one second sustain pulse to the plurality of discharge cells.

The controller is preferably further adapted to allocate the first number of sustain pulses to the at least one first subfield, to set a number of the at least one first sustain pulse to be equal to the second number, and to control a ratio of the second number relative to the first number.

The controller is preferably further adapted to set a number of the at least one second sustain pulse to be equal to a difference between the first and second numbers.

The controller is preferably further adapted to set the ratio of the second number relative to the first number according to a screen load ratio of the frame.

The controller is preferably further adapted to set the ratio of the second number relative to the first number according to a ratio of on-cells in the at least one first subfield.

The sustain pulses preferably alternately have a high level voltage and a low level voltage, and the controller is further adapted to preferably determine each of the first and second periods according to a time for increasing the sustain pulse from a value equal to a predetermined percentage of the low level voltage to a value equal to a predetermined percentage of the high level voltage and a time for decreasing the sustain pulses from a value equal to a predetermined percentage of the high level voltage to a value equal to a predetermined percentage of the low level voltage.

Still another exemplary embodiment of the present invention provides a plasma display including: a plurality of discharge cells; a controller adapted to divide one frame into a plurality of subfields each having a respective weight; and a driver adapted to supply at least one first sustain pulse and at least one second sustain pulse to the plurality of discharge cells during at least one of the plurality of subfields; the at least first sustain pulse alternately has a first voltage and a second voltage, and the at least one second sustain pulse has a third voltage and a fourth voltage; and a time in which a voltage of the at least one first sustain pulse is changed from a value equal to a predetermined percentage of the first voltage to a value equal to a predetermined percentage of the second voltage is different from a time in which a voltage of the at least one second sustain pulse is changed from a value equal to a predetermined percentage of the third voltage to a value equal to a predetermined percentage of the fourth voltage.

The at least one first sustain pulse preferably has a different period from the at least one second sustain pulse.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a top plan view of a plasma display according to an exemplary embodiment of the present invention.

FIG. 2 is a table of a subfield arrangement according to an exemplary embodiment of the present invention.

FIG. 3A is a waveform of sustain pulses allocated to one subfield according to an exemplary embodiment of the present invention.

FIG. 3B is a waveform of a sustain pulse of FIG. 3A.

FIG. 4 is a block diagram of a controller of a plasma display according to a first exemplary embodiment of the present invention.

FIG. 5 is a flowchart for determining a period ratio of a sustain pulse using a controller according to a first exemplary embodiment of the present invention.

FIG. 6 is a graph of the relationship between screen load ratios, sustain pulse period, and luminance.

FIG. 7 is a block diagram of a controller of a plasma display according to a second exemplary embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments can be modified in various different ways, all without departing from the spirit or scope of the present invention. Accordingly, the drawings and description are to be regarded as illustrative in nature and not restrictive. Like reference numerals designate like elements throughout the specification.

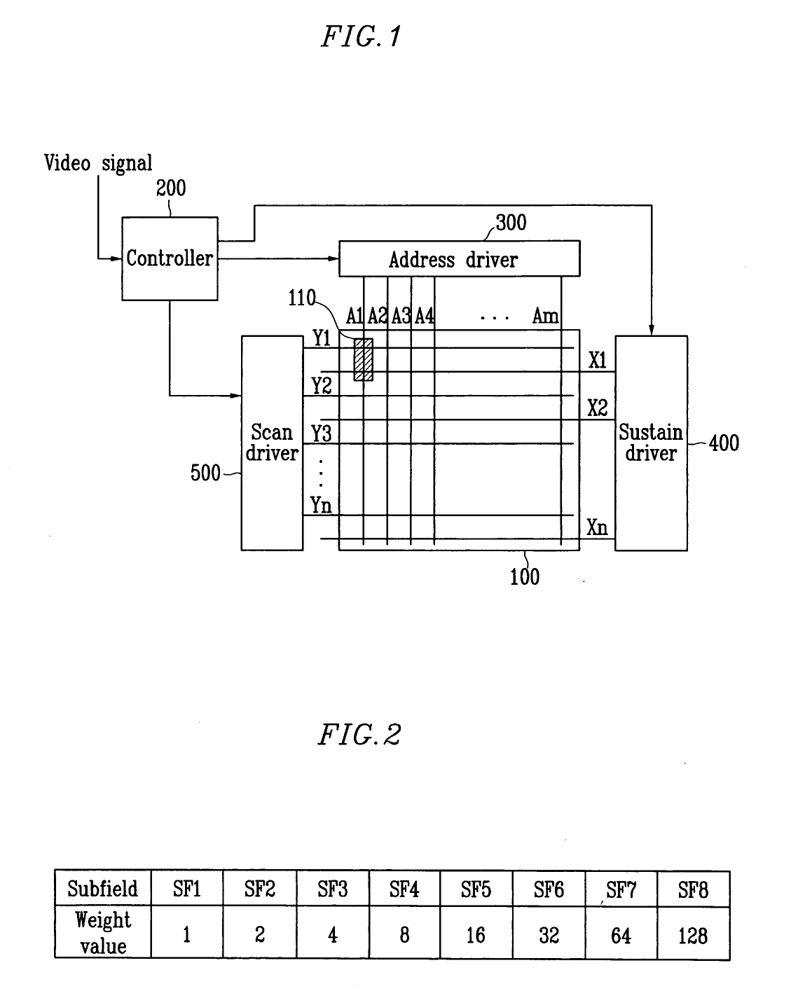

A plasma display and a driving method thereof according to an exemplary embodiment of the present invention is described below with reference to FIG. 1 to FIG. 3B.

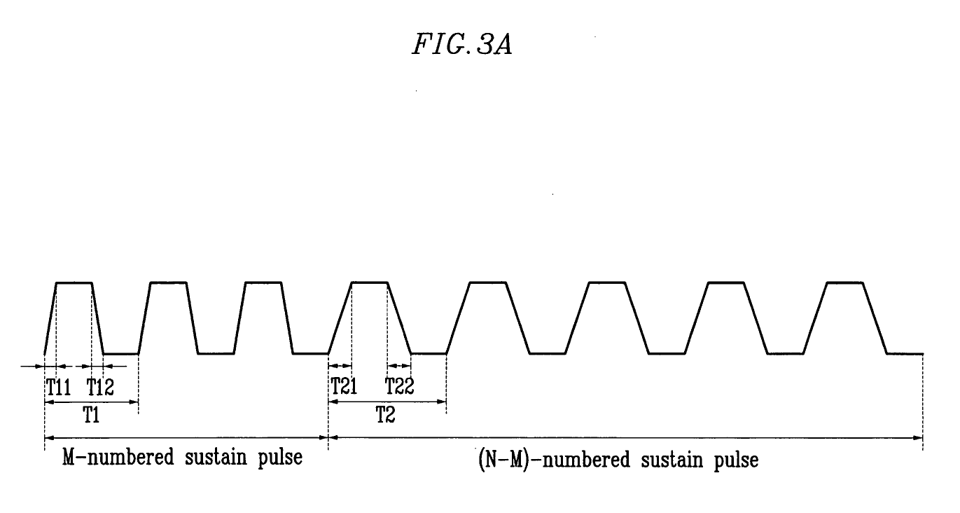

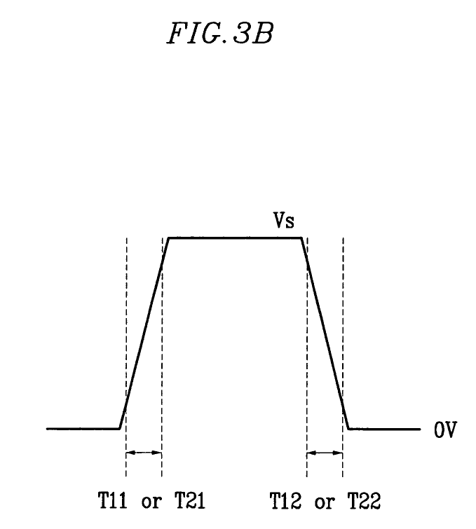

FIG. 1 is a top plan view of a plasma display according to an exemplary embodiment of the present invention, FIG. 2 is a table of a subfield arrangement according to an exemplary embodiment of the present invention, FIG. 3A is a waveform of sustain pulses allocated to one subfield according to an exemplary embodiment of the present invention, and FIG. 3B is a waveform of a sustain pulse of FIG. 3A.

As shown in FIG. 1, a plasma display according to an exemplary embodiment of the present invention includes a Plasma Display Panel (PDP) 100, a controller 200, an address electrode driver (hereinafter referred to as “A electrode driver”) 300, a sustain electrode driver (hereinafter referred to as “X electrode driver”) 400, and a scan electrode driver (hereinafter referred to as “Y electrode driver”) 500.

The PDP 100 includes a plurality of address electrodes A1 to Am (hereinafter referred to as “A electrodes”) extending in a column direction, and a plurality of sustain electrodes X1 to Xn (hereinafter referred to as “X electrodes”) and scan electrodes Y1-Yn (hereinafter referred to as “Y electrodes”) extending in a row direction in pairs. The X electrodes X1-Xn are formed in respective correspondence to the Y electrodes Y1-Yn, and adjacent X and Y electrodes define row electrodes. The A electrodes A1-Am cross the X electrodes X1-Xn and Y electrodes Y1-Yn. Discharge spaces are defined at regions where the A electrodes A1-Am cross the X and Y electrodes X1-Xn and Y1-Yn, and such discharge spaces define discharge cells 110.

As shown in FIG. 2, the controller 200 controls the plasma display by dividing a frame into a plurality of subfields SF1 to SF8 each having brightness weight. Each subfield include an address period and a sustain period. The controller 200 converts each of a plurality of video signals corresponding to the plurality of discharge cells 110 into a plurality of subfield data, and the plurality of subfield data represent whether or not the corresponding discharge cells 110 emits light in the subfields SF1 to SF8. It is assumed that the one frame is divided into eight subfields SF1 to SF8 respectively having weights 1, 2, 4, 8, 16, 32, 64, and 128 in FIG. 2, and thus, can express 0 to 255 grayscales. For example, the controller 200 can convert the video signal of 120 grayscale into subfield data of “00011110”. The “00011110” sequentially corresponds to the plurality of subfields SF1 to SF8, ‘1’ indicates a discharge cell in an on-state at the corresponding subfield and ‘0’ indicates a discharge cell in an off-state at the corresponding subfield.

The controller 200 determines a total number of sustain pulses allocated to the one frame and allocates the determined total number of sustain pulses to the plurality of subfields SF1 to SF8. The controller 200 can allocate the sustain pulses to the plurality of subfields SF1 to SF8 such that the number of sustain pulses allocated to the respective subfields is proportional to the weights for the respective subfields. In addition, the controller 200 determines a ratio between the number of sustain pulses having a first period and the number of sustain pulses having a second period, which is different from the first period, among the sustain pulses allocated to the respective subfields.

As shown in FIG. 3A, the controller 200 allocates N-numbered sustain pulses to a predetermined subfield. Among the N-numbered sustain pulses, M-numbered sustain pulses can have a first period T1 and (N-M)-numbered sustain pulses can have a second period T2. In addition, the sustain pulses can alternately have a high level voltage and a low level voltage. In one embodiment, the sustain pulses are supplied to the X and Y electrodes with reverse phase. In another embodiment, only one electrode of the X and Y electrodes are supplied with the sustain pulses and the other electrode is biased at a constant voltage. Since such a sustain pulse is supplied to the X electrode and/or Y electrode, a reactive power is consumed when the sustain pulse is changed from the high level voltage to the low level voltage and when the sustain pulse is changed from the low level voltage to the high level voltage. Accordingly, the X electrode and/or Y electrode driver 400 and 500 supplies a sustain pulse to the X electrode and/or Y electrode using resonance to recover and reuse the reactive power. The sustain pulse has a period determined by time T11 or T21 in which the voltage is increased, and time T12 or T22 in which the voltage is decreased due to the resonance.

As shown in FIG. 3B, assuming that the sustain pulse alternately has 0V and a voltage Vs, the rise time T11 or T21 is defined as a time in which the voltage of the X electrode or Y electrode is increased from a voltage 0.1 Vs to a voltage 0.9 Vs, and the fall time T12 or T22 is defined as a time in which the voltage of the X electrode or Y electrode is decreased from the voltage 0.9 Vs to the voltage 0.1 Vs. That is, the voltage change time of the sustain pulse is defined as a time for changing the voltage from 10% of the voltage Vs to 90% of the voltage Vs or a time for changing the voltage from 90% of the voltage Vs to 10% of the voltage Vs.

In the example shown in FIG. 3A, the sustain pulse has two periods T1 and T2. The sustain pulse can also have three or more periods as a constant ratio.

When the period of the sustain pulse is long, a discharge can occur while the voltage of the sustain pulse is increased. Then, since a current for the sustain discharge is not supplied from a power source for supplying the high level voltage, but rather is supplied from the resonance current, the sustain discharge becomes weaker. That is, since the sustain discharge is weaker when the period of the sustain pulse is long, the brightness varies depending on the ratio of the first and second periods of the sustain pulses even if the number of sustain pulses remains the same.

Subsequently, the controller 200 supplies driving control signals to the A electrode, X electrode, and Y electrode drivers 300, 400, and 500 according to the subfield data and the number of sustain pulses for the respective periods. The A electrode, X electrode, and Y electrode drivers 300, 400, and 500 supply a driving voltage to the respective A electrodes A1-Am, X electrodes X1-Xn, and Y electrodes Y1-Yn according to the driving control signals of the controller 200. In more detail, during the address period of each subfield, the A electrode, X electrode, and Y electrode drivers 300, 400, and 500 select on-cells and off-cells among the plurality of discharge cells 110. During the sustain period of each subfield, the X electrode and/or Y electrode drivers 400 and 500 supply the sustain pulses a number of times corresponding to a weight of a corresponding subfield to the X electrodes X1 to Xn and/or Y electrodes Y1 to Yn so that the on-cells are repeatedly sustain-discharged.

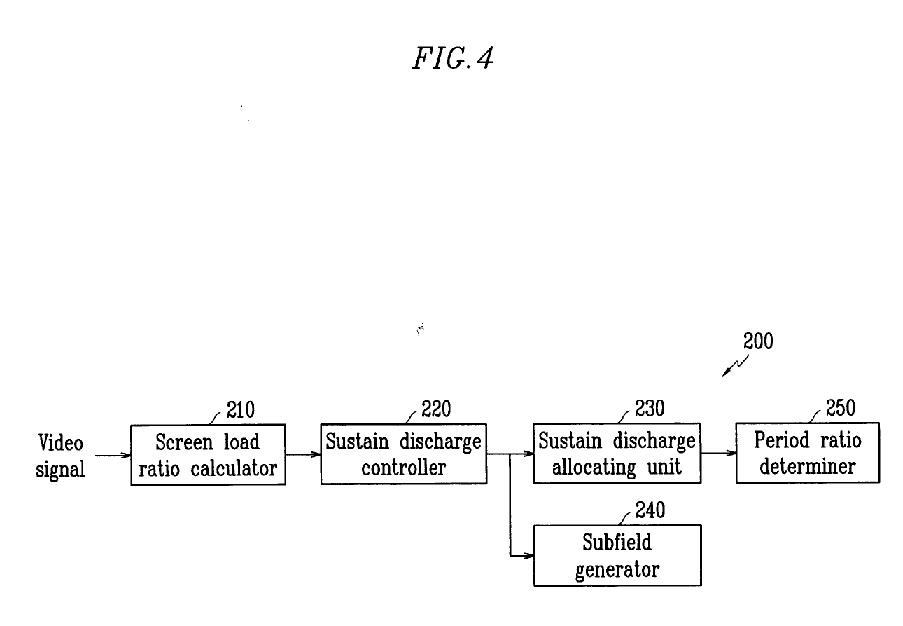

A method of the controller 200 determining a ratio of sustain pulses having different periods is described in detail below with reference to FIG. 4 to FIG. 6.

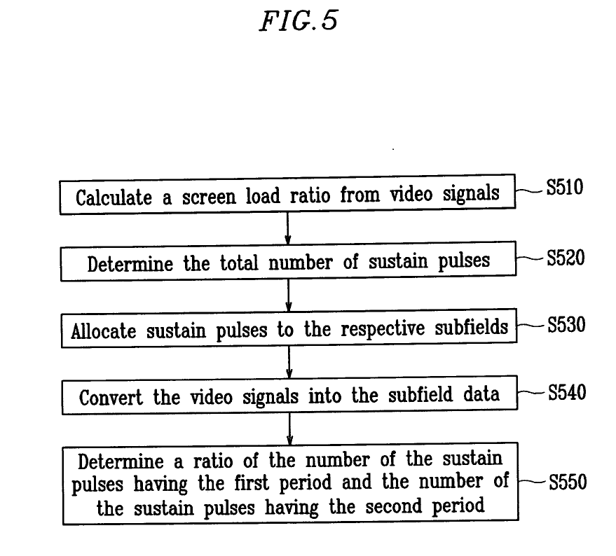

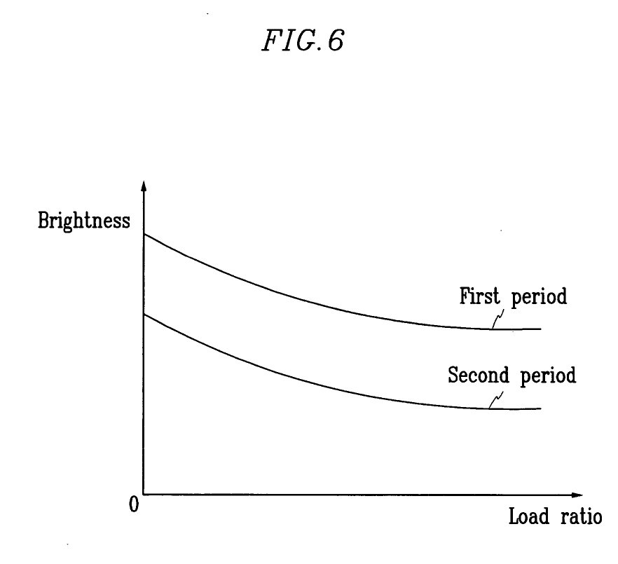

FIG. 4 is a schematic block diagram of a controller of a plasma display according to a first exemplary embodiment of the present invention, FIG. 5 is a flowchart for determining a period ratio of a sustain pulse using a controller according to a first exemplary embodiment of the present invention, and FIG. 6 is a graph of the relationship between screen load ratios, sustain pulse period, and luminance.

As shown in FIG. 4, the controller 200 includes a screen load ratio calculator 210, a sustain discharge controller 220, a sustain discharge allocating unit 230, a subfield generator 240, and a period ratio determiner 250.

As shown in FIG. 5, the screen load ratio calculator 210 calculates a screen load ratio from a plurality of video signals input during one frame (S510), for example, it can calculate the screen load ratio as an average level of the video signal of one frame. Herein, the plurality of video signals respectively corresponds to the plurality of discharge cells (see 110 of FIG. 1). The sustain discharge controller 220 determines the total number of sustain pulses allocated to one frame according to the screen load ratio (S520). In one embodiment, the sustain discharge controller 220 can store the total number of sustain pulses according to the screen load ratio as a lookup table. In another embodiment, the sustain discharge controller 220 can perform a logic operation of data corresponding to the screen load ratio and thus calculate the total number of sustain pulses. That is, when the screen load ratio becomes higher due to an increase in the number of on-cells, the total number of sustain pulses are decreased such that an increase in power consumption can be prevented. The sustain discharge allocating unit 230 allocates the sustain pulses corresponding to one frame to the plurality of subfields SF1 to SF8 such that the number of sustain pulses of each subfield is proportional to the weight of each subfield (S530). The subfield generator 240 converts the video signals into the subfield data (S540), the period ratio determiner 250 determines a ratio of the number of sustain pulses having a first period to the number of sustain pulses having a second period longer than the first period among the sustain pulses allocated to each subfield SF1 to SF8 (S550).

In more detail, as shown in FIG. 6, the brightness is decreased according to an increase of the screen load ratio. That is, the number of on-cells becomes increased according to an increase of the screen load ratio, and accordingly, the magnitude of current by the sustain discharges increases. Then, a voltage drop in the X and Y electrodes is increased and thus the intensity of the sustain discharges becomes weaker and the brightness decreases. Accordingly, the period ratio determiner 250 can increase a ratio M/N of the sustain pulses having the short period (the first period) because the brightness decreases in the case of the high screen load ratio. The period ratio determiner 250 can increase a ratio (N-M)/N of the long period (the second period) because the brightness increases in the case of the low screen load ratio. Then, the brightness L is given by Equation 1 below, and accordingly, a desired brightness can be set by controlling the ratio of the numbers of sustain pulses having the first and second periods although the brightness of the one sustain pulse is changed according to the screen load ratio.

$$\begin{matrix}Equation 1 \text{:} & \\ L = A \times \frac{M}{N} + B \times ( 1 - \frac{M}{N} ) & \end{matrix}$$

A is a brightness obtained by the M sustain pulses having the first period, and B is a brightness obtained by the N sustain pulses having the second period.

For example, as in Equation 2 below, the number M of sustain pulses having the first period can be determined by the product of the screen load ratio and the number N of sustain pulses allocated to the corresponding subfields, and the period of the other sustain pulses (i.e., the number (N-M) of sustain pulses) can be given by the second period. Then, the brightness characteristics of the sustain pulses can be constantly maintained regardless of the screen load ratio.
M=LR×N Equation 2

LR is the screen load ratio of one frame, and is equal to 1 in the case of the full white image.

While the period ratio of the sustain pulses has been determined by the screen load ratio of one frame in the first exemplary embodiment of the present invention, the period ratio of the sustain pulses can be determined by display load ratio of the one subfield.

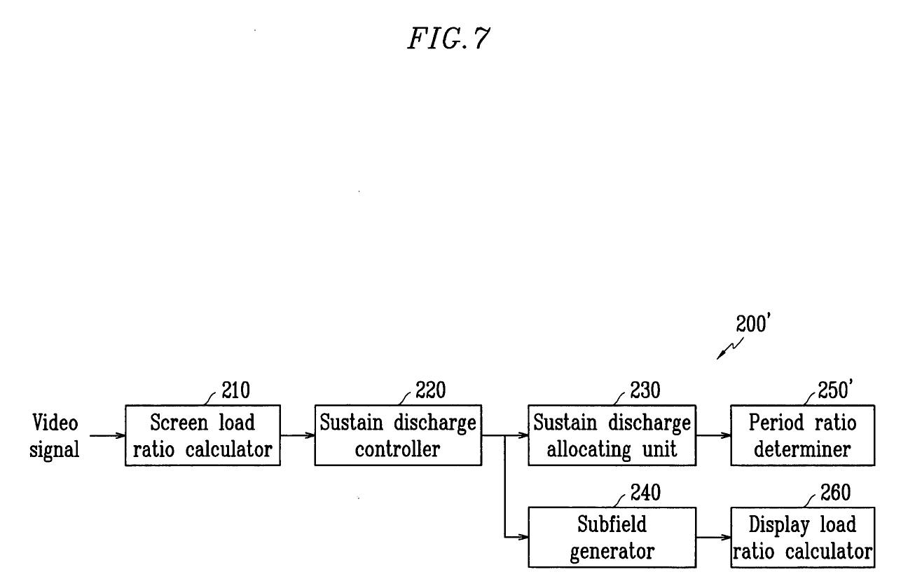

FIG. 7 is a schematic block diagram of a controller 200′ of a plasma display according to a second exemplary embodiment of the present invention.

As shown in FIG. 7, a controller 200′ according to the second exemplary embodiment further includes a display load ratio calculator 260. The display load ratio calculator 260 calculates a display load ratio with the subfield data of each subfield SF1 to SF8. That is, the display load ratio calculator 260 determines the display load ratio of the corresponding subfield as a ratio of the number of the entire discharge cells to the number of on-cells. In addition, the period ratio determiner 250′ determines the period ratio of the sustain pulses according to the display load ratio of the corresponding subfield at each subfield.

In more detail, when the sustain discharge controller 230 allocates Ni numbered sustain pulses to the i-th subfield SFi, the period ratio determiner 250′ determines the number Mi of the sustain pulses having the first period and the number (Ni-Mi) of the sustain pulses having the second period using Equation 3 below. Then, since the period ratio of the sustain pulse is determined according to the number of on-cells at each subfield, the brightness characteristics can be constantly maintained regardless of the number of on-cells for each subfield.
Mi=LRi×Ni Equation 3

LRi is the display load ratio of the i-th subfield SFi.

While the period ratio of the sustain pulse has been determined according to the load ratio in the exemplary embodiments of the present invention described above, the period ratio of the sustain pulse can be determined in other manners. In addition, the sustain pulses allocated to one subfield can use three or more periods.

According to an exemplary embodiment of the present invention, the brightness characteristics can be determined by the number of sustain pulses and the ratio of the numbers of sustain pulses having different periods.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

What is claimed is:

1. A method of driving a plasma display in which one frame is divided into a plurality of subfields each having a respective weight, the method comprising:
calculating a screen load ratio from a plurality of video signals input during one frame;
determining a total number of sustain pulses of the frame according to the screen load ratio;
determining a number of sustain pulses allocated to each subfield from the total number of sustain pulses; and
dividing a first number of sustain pulses allocated to at least one of the plurality of subfields into a second number of sustain pulses having a first period and a third number of sustain pulses having a second period different from the first period.

2. The method of claim 1, wherein each sustain pulse alternately has a high level voltage and a low level voltage, and wherein each of the first and second periods is determined by a first time in which the sustain pulse is increased from a value equal to a predetermined percentage of the low level voltage to a value equal to a predetermined percentage of the high level voltage and a second time in which the sustain pulse is decreased from a value equal to a predetermined percentage of the high level voltage to a value equal to a predetermined percentage of the low level voltage.

3. The method of claim 1, wherein determining the number of sustain pulses includes allocating the number of sustain pulses to the plurality of subfields such that the number of sustain pulses allocated to each subfield is proportional to the weight of the respective subfield.

4. The method of claim 1, wherein a ratio of the second number relative to the first number is increased in response to the screen load ratio increasing, and wherein the first period is shorter than the second period.

5. The method of claim 4, wherein the ratio of the second number relative to the first number corresponds to the screen load ratio.

6. The method of claim 1, further comprising:
converting each of the plurality of video signals into a plurality of subfield data; and
calculating a display load ratio of each subfield from the plurality of subfield data corresponding to the respective subfield;
wherein a ratio of the second number relative to the first number is increased in response to the display load ratio increasing; and
wherein the first period is shorter than the second period.

7. The method of claim 6, wherein the ratio of the second number relative to the first number corresponds to the display load ratio of each subfield.

8. The method of claim 1, wherein the third number is equal to a difference between the first number and the second number.

9. The method of claim 1, wherein the first number of sustain pulses further includes at least one sustain pulse having a third period different from the first and second periods.

10. A plasma display comprising:
a plurality of discharge cells;
a controller adapted to: divide one frame into a plurality of subfields each having a respective weight; allocate a plurality of sustain pulses to the plurality of subfields according to the weights thereof, and to divide sustain pulses allocated to at least one of the plurality of subfields into at least one first sustain pulse having a first period and at least one second sustain pulse having a second period; and
a driver adapted to supply the at least one first sustain pulse and the at least one second sustain pulse to the plurality of discharge cells.

11. The plasma display of claim 10, wherein the controller is further adapted to allocate the first number of sustain pulses to the at least one first subfield, to set a number of the at least one first sustain pulse to be equal to the second number, and to control a ratio of the second number relative to the first number.

12. The plasma display of claim 11, wherein the controller is further adapted to set a number of the at least one second sustain pulse to be equal to a difference between the first and second numbers.

13. The plasma display of claim 11, wherein the controller is further adapted to set the ratio of the second number relative to the first number according to a screen load ratio of the frame.

14. The plasma display of claim 11, wherein the controller is further adapted to set the ratio of the second number relative to the first number according to a ratio of on-cells in the at least one first subfield.

15. The plasma display of claim 10, wherein the sustain pulses alternately have a high level voltage and a low level voltage, and wherein the controller is further adapted to determine each of the first and second periods according to a time for increasing the sustain pulse from a value equal to a predetermined percentage of the low level voltage to a value equal to a predetermined percentage of the high level voltage and a time for decreasing the sustain pulses from a value equal to a predetermined percentage of the high level voltage to a value equal to a predetermined percentage of the low level voltage.

16. A plasma display, comprising:
a plurality of discharge cells;
a controller adapted to divide one frame into a plurality of subfields each having a respective weight; and
a driver adapted to supply at least one first sustain pulse and at least one second sustain pulse to the plurality of discharge cells during at least one of the plurality of subfields;
wherein the at least first sustain pulse alternately has a first voltage and a second voltage, and the at least one second sustain pulse has a third voltage and a fourth voltage; and
wherein a time in which a voltage of the at least one first sustain pulse is changed from a value equal to a predetermined percentage of the first voltage to a value equal to a predetermined percentage of the second voltage is different from a time in which a voltage of the at least one second sustain pulse is changed from a value equal to a predetermined percentage of the third voltage to a value equal to a predetermined percentage of the fourth voltage.

17. The plasma display of claim 16, wherein the at least one first sustain pulse has a different period from the at least one second sustain pulse.
